(19) United States
(12) Patent Application Publication
(10) Pub. No.: US 2011/0090669 A1
(43) Pub. Date: Apr. 21, 2011

(54) LED LIGHTING DEVICE AND LIGHT SOURCE MODULE FOR THE SAME

(76) Inventors: Tsung-Ting SUN, Chung-Ho City (TW); Chih-Wei Hsu, Chung-Ho City (TW)

(21) Appl. No.: 12/581,999

(22) Filed: Oct. 20, 2009

(51) Int. Cl. F21V 9/16

(52) U.S. Cl. 362/84; 362/231

(57) ABSTRACT

An LED lighting device includes a supporting stage, a light source module, a heat dissipating module and a sleeve. The light source module is arranged on one side of the supporting stage and includes a plurality of white LEDs, a plurality of red LEDs, and a plurality of green LEDs. The heat dissipating module includes a plurality of heat-dissipating fins and a plurality of heat pipes passing through the heat-dissipating fins. The sleeve encloses the heat dissipating module. The LED lighting device mixes the lights from those LEDs to provide a light source with lower color temperature and higher color rendering index.

### BACKGROUND OF THE INVENTION

1. Field of the Invention

The present invention relates to an LED lighting device, and more particular to an LED lighting device with lower color temperature and higher color rendering index.

2. Description of Prior Art

Light Emitting Diode (LED) is a kind of semiconductor device and primarily used for the applications such as indication lamp, traffic sign and sign board in its early history. The applications of LED extend to lighting field such as flashlight, vehicle light and even general lighting when white light LED is successfully developed. LED exploits the property of direct-bandgap semiconductor material to convert electric energy into light energy efficiently and has the advantages of long lifetime, low power consumption and high conversion efficiency. Moreover, LED device can be packaged by epoxy material, which provides good robustness. In a word, LED is a compact light source and can be used for miniature of electric appliance.

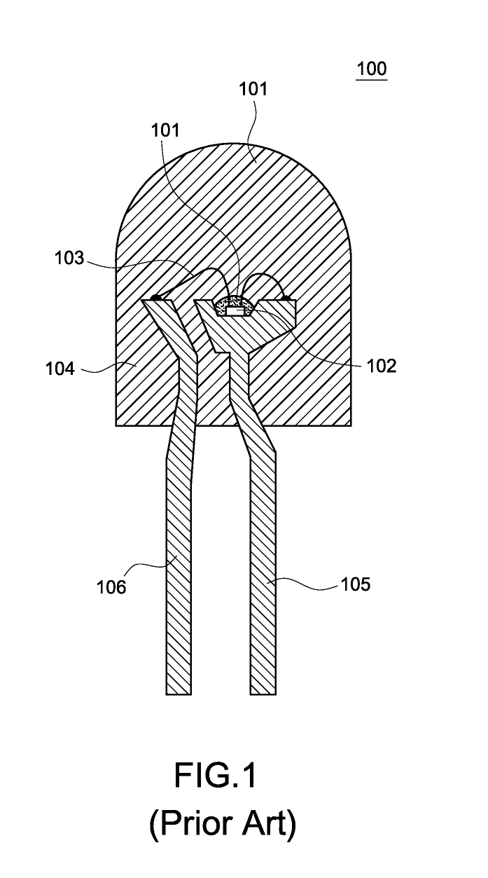

FIG. 1 shows a sectional view of a prior art lead type LED disclosed in U.S. Pat. No. 5,998,925, which has the title of “Light emitting device having a nitride compound semiconductor and a phosphor containing a garnet fluorescent material” and is filed by Nichia Chemical.

The white LED 100 in this prior art comprises a yellow phosphor 101, a blue LED chip 102, a plurality of metal wires 103, an epoxy mold 104, a mount lead 105 and an inner lead 106. The blue LED chip 102 emits blue light in the wavelength regime of 400 nm-530 nm and the yellow phosphor is a yttrium-aluminum-garnet (YAG) fluorescent material.

The blue LED chip 102 is mounted in a cavity atop the mount lead 105 and the pads (not shown) of the blue LED chip 102 are electrically connected to the mount lead 105 and the inner lead 106 through the metal wires 103. The blue LED chip 102 is enclosed by the yellow phosphor 101 and the yellow phosphor 101 is enclosed by the epoxy mold 104 to provide a rigid shape. The epoxy mold 104 can be replaced by silicone rubber.

In the above-mentioned white LED 100, the yellow phosphor 101 is excited by the blue light of the blue LED chip 102 and emits a yellow light, the emitted yellow light is mixed with the blue light to generate white light.

In general lighting application, light source with quality similar to sun light is desirable. Therefore, the white LED preferably has the spectral property, color rendering index and color temperature similar to those of sun light for general lighting application.

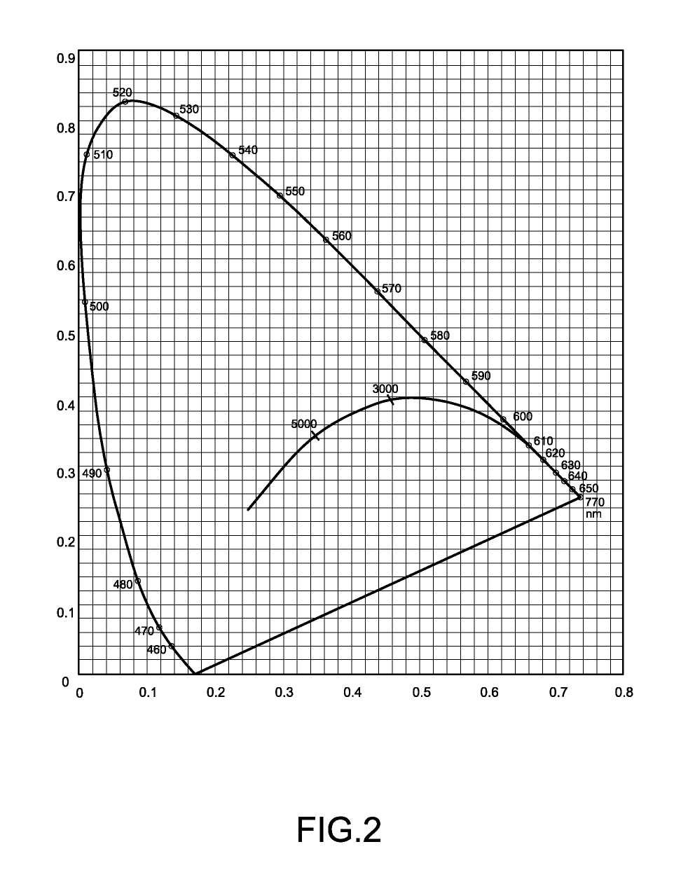

Color temperature is a characteristic of visible light in terms of absolute temperature (Kelvins, K). The color temperature of a light source is determined by comparing its chromaticity with that of an ideal black-body radiator. The temperature at which the heated black-body radiator matches the color of the light source is that source's color temperature. When temperature rises, the corresponding color of the black body changes from reddish, orange-red, white, bluish white and then to blue color. The color change contour can be manifested through chromaticity coordinate, such as CIE1931 coordinate, where the contour is a curve as shown in FIG. 2. When the color temperature is below 3000K, the corresponding color is reddish and warm; when the color temperature is above 5000K, the corresponding color is bluish and cold.

The color rendering index (CRI) is a quantitative measure of the ability of a light source to reproduce the colors of various objects faithfully. Light sources with a high CRI are desirable because an object illuminated by the light sources has faithful color, which is close to the ideal color with natural light source.

However, in the white LED composed of blue LED chip 102 and yellow phosphor 101, blue light component occupies major portion of the white light spectrum. The color temperature is high (around 6000K). Moreover, the red light component in this white light is not sufficient and the color rendering index of the white LED is poor.

To solve above problem, red phosphor and green phosphor are added in the packaging process of the white LED, thus reducing color temperature and enhancing color rendering index. However, the uniformity of the phosphor is difficult to control and the property of thus-formed white LED is not ideal yet. It is desirable to provide white LED lighting device with reducing color temperature and enhancing color rendering index.

### SUMMARY OF THE INVENTION

It is an object of the present invention to provide a light source module using LED and having lower color temperature and higher color rendering index to overcome the problems in conventional LED light source.

It is another object of the present invention to provide an LED lighting device using the above-mentioned light source module.

Accordingly, the present invention provides a light source module, which comprises plurality of white LEDs, a plurality of red LEDs, and a plurality of green LEDs.

Each white LED comprises a blue LED chip and yellow phosphor to provide a white light with broad spectrum. Each red LED emits red light with wavelength between 585 nm to 630 nm; and each green LED emits green light with wavelength between 515 nm to 535 nm. The light source module mixes the lights of those LEDs to provide light with lower color temperature and higher color rendering index than the original white light provided by the white LED alone.

According to another aspect of the present invention, the present invention provides an LED lighting device using the above-mentioned light source module and comprising a supporting stage, the light source module mentioned above, a heat dissipating module and a sleeve.

The supporting stage further comprises a main body, a cylinder extended from a bottom face of the main body and a metal base located at top face of the main body. The metal base can be aluminum plate. The light source module is arranged on one side (such as top side) of the supporting stage and comprises a plurality of white LEDs, a plurality of red LEDs, and a plurality of green LEDs. Each white LED comprises a blue LED chip and yellow phosphor to provide a white light with broad spectrum. Each red LED emits red light with wavelength between 585 nm to 630 nm; and each green LED emits green light with wavelength between 515 nm to 535 nm.

The heat dissipating module comprises a plurality of heat-dissipating fins and a plurality of heat pipes passing through the heat-dissipating fins. The heat dissipating module encloses the cylinder of the supporting stage. The sleeve encloses the heat dissipating module and is locked to the supporting stage.

The LED lighting device according to the present invention further comprises a transparent protection cover in front of the light source module, and the transparent protection cover protects the light source module from collision with foreign articles.

The LED lighting device according to the present invention mixes the light from LEDs of three different colors and provides a light source with lower color temperature and higher color rendering index. The LED lighting device according to the present invention has simple manufacture process and lower cost in comparison with LED lighting device with phosphor of different colors.

BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of a prior art lead type LED.

FIG. 2 shows a CIE1931 chromaticity chart.

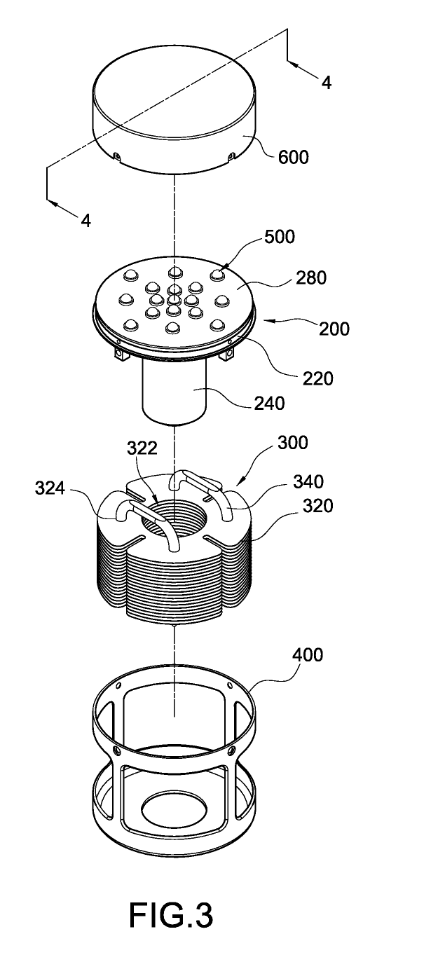

FIG. 3 shows the exploded view for the LED lighting device according to the present invention.

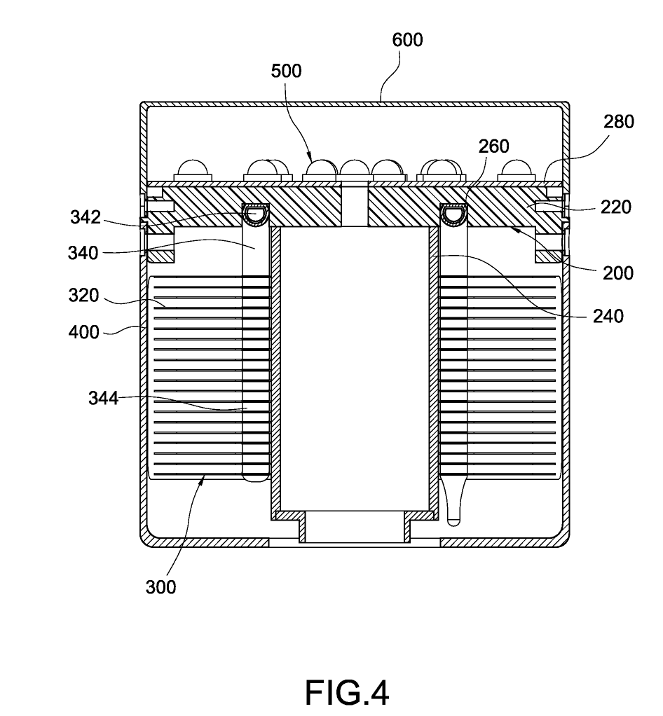

FIG. 4 shows the sectional view for the LED lighting device according to the present invention.

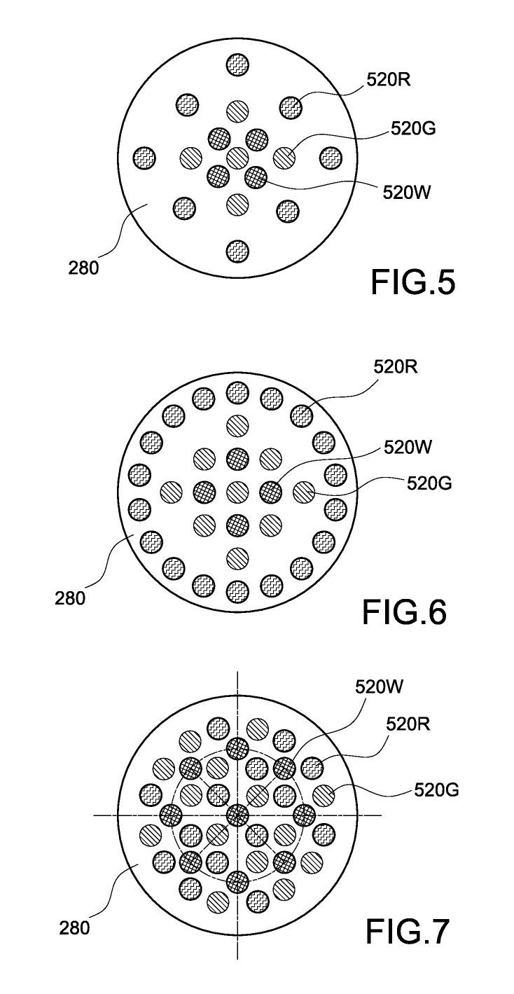

FIG. 5 is a schematic view of the arrangement of the light source module according to a preferred embodiment of the present invention.

FIG. 6 is a schematic view of the arrangement of the light source module according to another preferred embodiment of the present invention.

FIG. 7 is a schematic view of the arrangement of the light source module according to still another preferred embodiment of the present invention.

### DETAILED DESCRIPTION OF THE INVENTION

FIG. 3 and FIG. 4 show the exploded view and sectional view for the LED lighting device according to the present invention, respectively. The LED lighting device comprises a supporting stage 200, a heat dissipating module 300, a sleeve 400 and a light source module 500.

The supporting stage 200 comprises a main body 220, a cylinder 240 extended from a bottom face of the main body 220 and a metal base 280 located at top face of the main body 220 and used to mount the light source module 500, where the metal base 280 can be, for example, aluminum plate. With reference also to FIG. 4, the supporting stage 200 further comprises two locking slots 260 defined at the bottom face thereof

The heat dissipating module 300 comprises a plurality of heat-dissipating fins 320 and a plurality of heat pipes 340. Those heat-dissipating fins 320 are stacked to each other and each comprises a center hole 322 and a plurality of lobes (not labeled) around the center hole 322. Moreover, each lobe of the heat-dissipating fin 320 comprises a bore 324. The center hole 322 is adapted to receive the cylinder 240 of the supporting stage 200. Each of the heat pipes 340 is of U shape and comprises a flat evaporating end 342 and two condensing ends 344 connected through the flat evaporating end 342. The condensing ends 344 are fit into the locking slots 260 defined at the bottom face of the main body 220, while the flat evaporating end 342 passes through the bores 324. One end of the condensing ends 344 is locked through a screw (not shown).

The sleeve 400 is a cylindrical hollow body and encloses the heat dissipating module 300. Moreover, the sleeve 400 is locked to the circumference of the main body 220 to support and retain the heat dissipating module 300.

The light source module 500 is arranged at top face of the metal base 280 and (with reference to FIGS. 5 to 7) comprises a plurality of white LEDs 520W, a plurality of red LEDs 520R, and a plurality of green LEDs 520G. More particularly, each of the white LED 520W is formed by blue LED chip with yellow phosphor. The red LED 520R emits red light in the wavelength regime between 585 nm and 630 nm. More preferably, the red LED 520R emits red light in the wavelength regime between 585 nm and 595 nm, or between 620 nm and 630 nm. The green LED 520G emits green light in the wavelength regime between 515 nm and 535 nm.

The red LEDs 520R and the green LEDs 520G are used to provide red light source and green light source for the light source module 500, respectively. The white LEDs 520W are inherently light source of high color temperature, and the red LEDs 520R and the green LEDs 520G reduce overall color temperature of the light source module 500. Moreover, the red LEDs 520R and the green LEDs 520G enhance the color rendering index of the light source module 500 such that an object illuminated by the light source module 500 has natural color.

FIG. 5 is a schematic view of the arrangement of the light source module 500 according to a preferred embodiment of the present invention. There are totally 17 LEDs including 4 white LEDs 520W, 8 red LEDs 520R, and 5 green LEDs 520G. The green LEDs 520G are arranged at center of the metal base 280 in cross shaped fashion, while a central green LED 520G is located at center of the metal base 280. The white LEDs 520W are each arranged between adjacent green LEDs 520G, while the red LEDs 520R circle around the white LEDs 520W and the green LEDs 520G.

FIG. 6 is a schematic view of the arrangement of the light source module 500 according to another preferred embodiment of the present invention. There are totally 31 LEDs including 4 white LEDs 520W, 18 red LEDs 520R, and 9 green LEDs 520G. The red LEDs 520R are arranged at perimeter of the metal base 280 at equi-distance and annular fashion. One of the green LEDs 520G is located at center of the metal base 280, while the white LEDs 520W circle around the center green LED 520G The remained eight green LEDs 520G circle around the white LEDs 520W at equi-distance manner.

FIG. 7 is a schematic view of the arrangement of the light source module 500 according to still another preferred embodiment of the present invention. There are totally 37 LEDs including 9 white LEDs 520W, 14 red LEDs 520R, and 14 green LEDs 520G. One of the white LEDs 520W is located at center of the metal base 280, and the remaining 8 white LEDs 520W circles around the center white LED 520W with equal distance (namely, one white LED 520W at each of the octant division lines of the metal base 280) therebetween.

Provided that the metal base 280 is divided to four portions, namely, the upper-right portion, the lower-right portion, the upper-left portion and the lower-left portion. More particularly, the LEDs arranged at the upper-right portion are symmetrical to those at the lower-left portion. The LEDs arranged at the lower-right portion are symmetrical to those at the upper-left portion.

The LEDs at the upper-right portion of the metal base 280 include a green LED 520G at the octant division line and between the center white LED 520 and the white LED 520 at the octant division line, and two red LEDs 520R between the above-mentioned green LED 502G and the white LED 520 at the octant division line. The LEDs at the upper-right portion of the metal base 280 further include four LEDs at the outer circumference of the white LED 520 at the octant division line, where the four outer LEDs includes, along clockwise direction, a green LED 520G, two red LEDs 520R and a green LED 520G.

The LEDs at the lower-right portion of the metal base 280 include a red LED 520R at the octant division line and between the center white LED 520 and the white LED 520 at the octant division line, and two green LEDs 520G between the above-mentioned red LED 502R and the white LED 520 at the octant division line. The LEDs at the lower-right portion of the metal base 280 further include four LEDs at the outer circumference of the white LED 520 at the octant division line, where the four outer LEDs includes, along clockwise direction, a red LED 520R, two green LEDs 520G and a red LED 520R.

The rule for the number of LEDs used can be summarized with regarding to the above three examples. Provided that the number of white LED 520W used is n_{W}, the number of red LED 520R used is n_{R}, and the number of green LED 520G used is n_{G}, then the number of LEDs used should obey the formula: n_{W}<n_{G}≦n_{R}. More particularly, the number of the green LEDs 520G used is larger than the number of the white LEDs 520W used; and the number of the red LEDs 520R used is larger than or equal to the number of the green LEDs 520G used.

Moreover, the LED lighting device according to the present invention further comprises a transparent protection cover 600 in front of the light source module 500, and the transparent protection cover 600 protects the light source module 500 from collision with foreign articles.

To sum up, the LED lighting device according to the present invention mixes the light from LEDs of different color and provides a light source with lower color temperature and higher color rendering index. The LED lighting device according to the present invention has simple manufacture process and lower cost in comparison with LED lighting device with phosphor of different colors.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light source module, comprising:
a plurality of white light emitting diodes (LEDs), each white LED comprising a blue LED chip and yellow phosphor to provide a white light with broad spectrum;
a plurality of red LEDs, each red LED emitting red light with wavelength between 585 nm to 630 nm; and
a plurality of green LEDs, each green LED emitting green light with wavelength between 515 nm to 535 nm,
where the light source module mixes the lights emitted from those LEDs to form light with lower color temperature and higher color rendering index than the white light provided by the white LED.

2. The light source module in claim 1, wherein the red light has wavelength between 585 nm to 595 nm.

3. The light source module in claim 1, wherein the red light has wavelength between 620 nm to 630 nm.

4. The light source module in claim 1, wherein the number of the green LEDs is larger than the number of the white LEDs.

5. The light source module in claim 4, wherein the number of the red LEDs is larger than the number of the green LEDs.

6. The light source module in claim 4, wherein the number of the red LEDs is equal to the number of the green LEDs.

7. An LED lighting device, comprising:
a supporting stage;
a light source module arranged on one side of the supporting stage and comprising
a plurality of white LEDs, each white LED comprising a blue LED chip and yellow phosphor to provide a white light with broad spectrum;
a plurality of red LEDs, each red LED emitting red light with wavelength between 585 nm to 630 nm; and
a plurality of green LEDs, each green LED emitting green light with wavelength between 515 nm to 535 nm;
a heat dissipating module arranged on another side of the supporting stage and opposite to the light source module; and
a sleeve for enclosing the heat dissipating module.

8. The LED lighting device in claim 7, wherein the supporting stage further comprises a main body, a cylinder extended from a bottom face of the main body and a metal base located at a top face of the main body.

9. The LED lighting device in claim 7, further comprising a protection cover placed in front of the light source module.

10. The LED lighting device in claim 7, wherein the red light has wavelength between 585 nm to 595 nm.

11. The LED lighting device in claim 7, wherein the red light has wavelength between 620 nm to 630 nm.

12. The LED lighting device in claim 7, wherein the number of the green LEDs is larger than the number of the white LEDs.

13. The LED lighting device in claim 11, wherein the number of the red LEDs is larger than the number of the green LEDs.

14. The LED lighting device in claim 11, wherein the number of the red LEDs is equal to the number of the green LEDs.

15. The LED lighting device in claim 7, wherein the heat dissipating module comprises a plurality of heat-dissipating fins and a plurality of heat pipes passing through the heat-dissipating fins.

16. The LED lighting device in claim 8, wherein the metal base is aluminum plate.
